(19) United States
(12) Patent Application Publication
(10) Pub. No.: US 2004/0173240 A1
(43) Pub. Date: Sep. 9, 2004

(54) Brush for a blanket wash system

(76) Inventor: Paul Harris, York (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/662,190

(22) Filed: Sep. 12, 2003

Related U.S. Application Data
(60) Provisional application No. 60/410,600, filed on Sep. 13, 2002.

(51) Int. Cl. B08B 3/02

(52) U.S. Cl. 134/2; 134/25.4; 134/42; 134/182; 134/902; 134/200

(57) ABSTRACT

A blanket wash head for cleaning the blanket cylinder of a printing press comprises a plurality of bristles arranged on a brush that are sized to contact a flicker bar disposed within the blanket wash head. The bristles are arranged to travel along a path and to collect debris and/or moisture. The bristles comprises a leading bristle and a trailing bristle and, in response to rotation of the brush, an end of the trailing bristle swings along an arc caused by contact with a flicker bar. The bristles are spaced on the brush according to a low density cause the trailing bristle to swing though an arc a sufficient distance sufficient to dislodge the debris without interference with the leading bristle.

### RELATED APPLICATIONS

This application claims priority from U.S. Provisional Application Ser. No. 60/410,600, filed Sep. 13, 2002.

### FIELD OF THE INVENTION

The present invention relates generally to blanket cylinder cleaning systems used on printing presses and, more particularly, to an improved brush for use with a blanket cylinder cleaning system.

### BACKGROUND OF THE INVENTION

On a printing press, the blanket cylinders must be periodically cleaned in order to maintain a desired level of print quality. The blanket cylinders also must be cleaned when changing over to a different print run, especially when changing colors.

Conventionally, such cleaning operations have been performed manually, with crews using cleaning cloths soaked in volatile solvents to clean the blanket cylinders. Such manual cleaning operations are very labor intensive and time consuming, both of which increase labor costs and lengthen the down time or changeover time of the printing press. Moreover, the printing press environment is often hot due at least in part to heat radiation from the cylinders. The increased physical strain on cleaning and maintenance crews again increases costs and lowers productivity. Finally, the manual cleaning operations also divert the cleaning crew from other cleaning and maintenance operations, such as cleaning the inking systems, cleaning the doctor blades for the dampening brush rollers and other routine tasks.

Consequently, in an effort to reduce labor costs, shorten down time and/or changeover time, and to increase the overall productivity of the printing press, automatic blanket cylinder cleaning systems were developed. Such automated cleaning systems use a driven and oscillating brush system that reduces or eliminates the need for manual cleaning using solvent-soaked cleaning cloths. Such systems also reduce the consumption of solvents and the associated volatile organic carbon (VOC) emissions often associated with solvent use.

Unfortunately, some brush designs typically used in such automated cleaning systems may be prone to being clogged with debris, such as lint from the paper web. Such conventional brushes also may be prone to trapping moisture. Trapped moisture and/or trapped debris can eventually make the cleaning brush act more like a solid roller, in which case neither the debris nor the excess moisture is removed from the roller being cleaned. In such situations, the cleaning system may become effectively useless and the brush must be replaced.

### BRIEF DESCRIPTION OF THE DRAWINGS

FIG. 1 is a schematic cross-sectional view of an automated blanket cylinder cleaning system employing a rotating brush;

FIG. 2 is a fragmentary elevational view of a deteriorated brush of the type conventionally used on the cleaning system of FIG. 1;

FIG. 3 is an enlarged fragmentary view in perspective showing a brush similar to that shown in FIGS. 1 and 2 in a deteriorated state and clogged with debris;

FIG. 4 is an enlarged fragmentary view in perspective showing a brush similar to that shown in FIG. 3 saturated with moisture;

FIG. 5 is an enlarged fragmentary view in perspective showing a brush for use with automated blanket cleaning systems and assembled according to the teachings of the present invention; and

FIG. 6 is a schematic plan view of the blanket wash head illustrating the movement of the wash head toward and away from the blanket cylinder and also illustrating an oscillating mechanism;

FIG. 7 is an enlarged schematic view of a brush having a spiral or helically flighted bristle arrangement;

FIG. 8 is an enlarged schematic view of a brush having transversely oriented rows of bristles;

FIG. 9 is an enlarged schematic view of a brush having longitudinally oriented rows of bristles;

FIG. 10 is an enlarged fragmentary view of a brush having bristles arranged in clumps;

FIG. 11 is an enlarged fragmentary view illustrating an arcuate path traveled by the end of a bristle relative to the base of the bristle in response to contact with the flicker bar.

### DETAILED DESCRIPTION OF THE PREFERRED EMBODIMENT

The following detailed description is not intended to limit the scope of the invention to the precise form or forms disclosed herein. Instead, the embodiment illustrated herein has been chosen and described in order to best explain the principles of the invention so that others skilled in the art may follow its teachings.

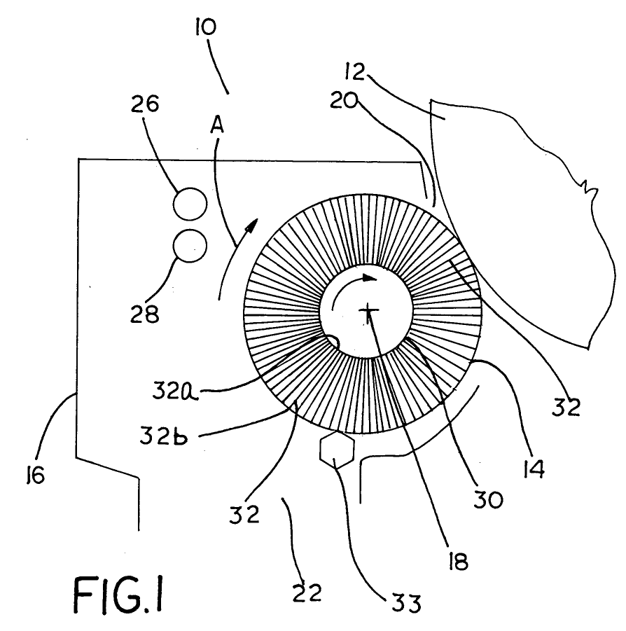

Referring now to FIG. 1 of the drawings, a blanket cylinder cleaning system 10 is shown in FIG. 1 and is positioned closely adjacent to a blanket cylinder 12 to be cleaned. Those of skill in the art will realize that the blanket cylinder cleaning systems actually clean the blanket attached to the blanket cylinder, rather than cleaning the blanket cylinder itself. For purposes of the following discussion, it will be assumed that the blanket cylinder 12 is carrying a blanket to be cleaned. Further, although the cleaning system 10 is shown in conjunction with a blanket cylinder 12, those of skill in the art will readily understand that the cleaning system 10 may also be used to clean other cylinders or rollers commonly found in a printing press.

The cleaning system 10 includes a brush 14 rotatably mounted within a blanket wash head or housing 16 and is driven by a suitable drive motor (not shown). Preferably, the brush 14 may also be mounted within the housing 16 so as to be oscillated back and forth along an axis of rotation 18. The housing 16 includes an opening 20 adjacent the blanket cylinder 12, and also includes an opening 22 which may serve as a drain or outlet for excess moisture and/or debris from within the housing 16 such that excess moisture and/or debris does not build up within the housing 16. Preferably, the entire housing 16 may be extended and retracted toward and away, respectively, relative to the blanket cylinder 12 using a carriage arrangement 17 (FIG. 6) in a known manner. Further, the oscillation of the brush along its rotational axis 18 may be carried out using a conventional cam mechanism 19 (FIG. 6) or other suitable mechanisms. In accordance with the disclosed example, the housing 16 may be shifted toward and away from the blanket cylinder 12 along a generally linear path, while only the brush 14, rather than the entire housing 16, is oscillated back and forth along the axis 18.

The cleaning system 12 also includes a pair of spray bars 26, 28 for spraying, for example, water or a cleaning solution. The spray bars 26, 28 may be of conventional design and of the type commonly used in blanket cylinder wash heads. The brush 14 includes a central shaft 30 and a plurality of radially extending bristles 32. Each bristle includes a base 32a and an outer end 32b. It will be understood that the outer end 32b of each bristle 32 travels along a circumferential path designated by the reference arrow A. A flicker bar 33 is mounted closely adjacent to the outward extent of the bristles 32 (i.e., closely adjacent to the outer circumference of the brush 14), such that the outer end 32b of each bristle 32 makes contact with the flicker bar 33 when the brush is rotated.

As shown in FIG. 6, the wash head or housing 16 is moveable along the carriage assembly of conventional construction between a retracted position spaced away from the cylinder 12 and an in-use position disposed adjacent to the cylinder 12 such that contact between the brush 14 and the cylinder 12 is possible. A conventional drive motor M may be used to rotate the brush 14, while the brush 14 is oscillated back and forth along its axis 18 using the conventional cam mechanism 19 or other suitable system.

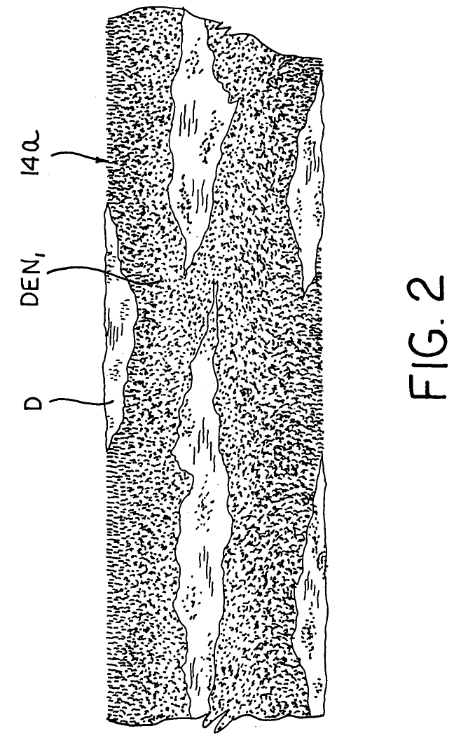

Referring now to FIGS. 2-4, a brush 14a shown therein in fragmentary form is a conventional prior art blanket cylinder cleaning brush. The bristles B of the prior art brush 14a are formed of a Nylon material having a bristle diameter (BD₁) of about six thousandths of an inch (0.006″). In the example shown, the bristles B are disposed on the central shaft of the conventional brush 14a according to a first density DEN₁. The Nylon bristles B of the conventional brush 14a are known to exhibit an absorbency rate of ABS₁ due at least in part to the conventional Nylon material. Further, the Nylon bristles B of the brush 14a will exhibit a stiffness characteristic S₁, which, for purposes of discussion herein, will generally be acknowledged to be relatively flexible. The flexibility of the bristles B is due, at least in part, to the relatively thin construction of the bristles B and to their material. The brush 14a is of the type conventionally employed on blanket cylinder cleaning systems and in all respects is well known to those of skill in the relevant art.

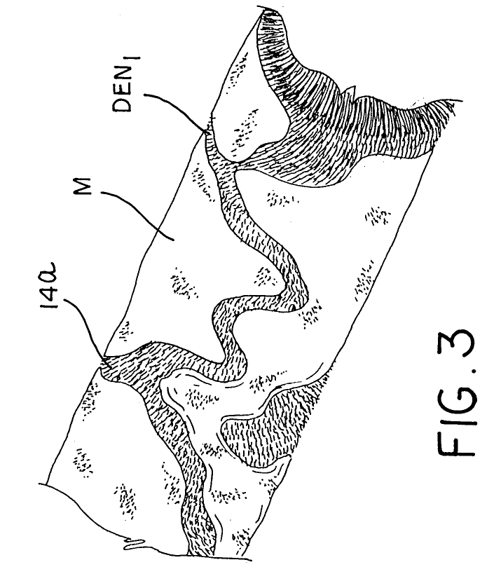

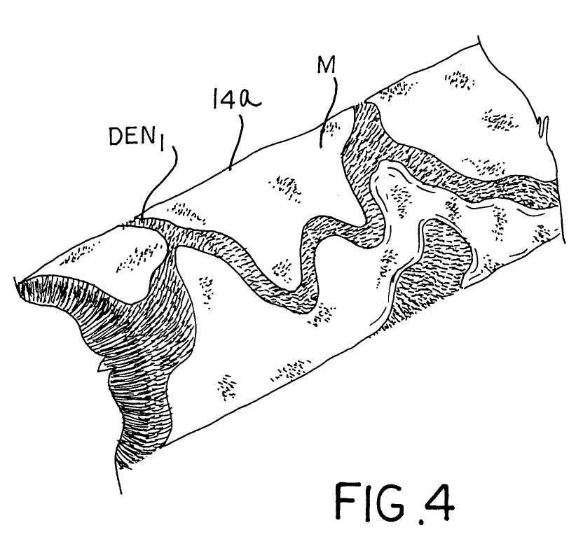

As shown in FIG. 2, the conventional brush 14a may, under certain circumstances, accumulate debris or clumps of debris indicated as D. As shown in FIGS. 3 and 4, the conventional brush 14a may also, under certain circumstances, accumulate moisture M, either alone or in conjunction with the debris D. Based on the above-described circumstances and conditions often encountered in use, in some applications the conventional brush 14a may be less stiff and more absorbent than may be desired. Thus the conventional brush 14a, in certain situations, may become experience a diminished capacity to effectively remove lint, debris, moisture, or other forms of unsuitable build-up from the blanket cylinder 12. When this occurs, the brush 14a may become clogged and, thereafter, the brush 14 may act more like a solid roller, resulting in a less aggressive cleaning action with no “bite.” Such an undesirable result can be viewed in FIGS. 2 and 3.

Further, because the conventional bristles B are tightly packed together due to the higher density DEN₁, water or other moisture from the dampening system or other sources becomes trapped in the brush by capillary action. Such a moisture saturated brush 14a can be viewed in FIGS. 3 and 4. This stored or trapped water or moisture may be subject to being transferred to the web when the wash cycle is commenced, which may lead to web breaks and increased downtime and loss of productivity. Finally, the required “flicking” action which ideally helps to keep the brush clean does not occur or is less likely to occur due to the high bristle density of the brush and the overly flexible bristles B. This may cause build up of debris as can be seen in FIG. 2. In such circumstances, a more conventional brush may require more frequent attention in order to return the brush to a suitable condition. Finally, the Nylon bristles have a relatively high water and/or solvent absorbency rate as discussed above, which may cause the characteristics of the bristles to change shortly after the initial use of the brush.

Referring now to FIG. 5, the brush 14 assembled in accordance with the teachings of a first disclosed example of the present invention is shown. The bristles 32 of the brush 14 are formed of a Polyester material, such as PBT polyester. Other forms of polyester, along with other materials, may be found to exhibit suitable properties of the type hereinafter described. The bristles 32 preferably have a bristle diameter BD₂ of about twelve thousandths of an inch (0.012″), although a thickness in the range of about 9 thousandths of an inch (0.009″) to about 16 thousandths of an inch (0.016″) may prove suitable.

In the example shown, the bristles 32 are also disposed on the central shaft 30 (FIG. 1) according to a second density DEN₂. The second density DEN₂ is in the range of about twenty five percent (25%) to about fifty percent (50%) less than the density DEN₁ found on the conventional brush 14a discussed above. Also, the polyester bristles 32 of the brush 14 will preferably exhibit an absorbency rate of ABS₂ due at least in part to the polyester material. The absorbency rate ABS₂ is preferably about 0.5%, which is less than the known absorbency rate of Nylon bristles B used in the prior art conventional brush 14a. Further, the Polyester bristles 32 of the brush 14 will exhibit a stiffness characteristic S₂, which, for purposes of discussion herein, will generally be acknowledged to be relatively stiff when compared to the stiffness S₁ of the conventional brush 14 discussed above. Given the greater stiffness S₂ desired for the present bristles 32, and using the length of the bristle along with the material properties such as the modulus of elasticity for the chosen PBT polyester material, the diameter may be adjusted to account for a change in bristle length. In the disclosed example, the brush 14 may have an outer diameter of about fifty-five millimeters (55 mm) as is commonly found on a conventional brush used in a blanket cylinder wash head system. The brush 14 may also have an exposed bristle length (the distance from the outer surface of the central shaft 30 to the end 32b of the bristle) of about twenty-five millimeters to about thirty millimeters (25 mm to 30 mm). Thus, using the central shaft diameter of about 25 mm to about 30 mm, the ratio of the bristle length to its diameter may be expressed as the ratio L/diameter. In its preferred form, and using an bristle length of between 25 mm (0.98 inches) and 30 mm (1.18 inches) for a bristle having a diameter of 0.012 inches, the resultant ration may range between about 81.7 and about 98.3. This ration may be compared to a conventional bristle, using the same length range and a diameter of 0.006 inches, resulting in a ratio range of between 163.3 and about 196.7. Using conventional engineering principles, it will be understood that an element having a lower ratio will be stiffer.

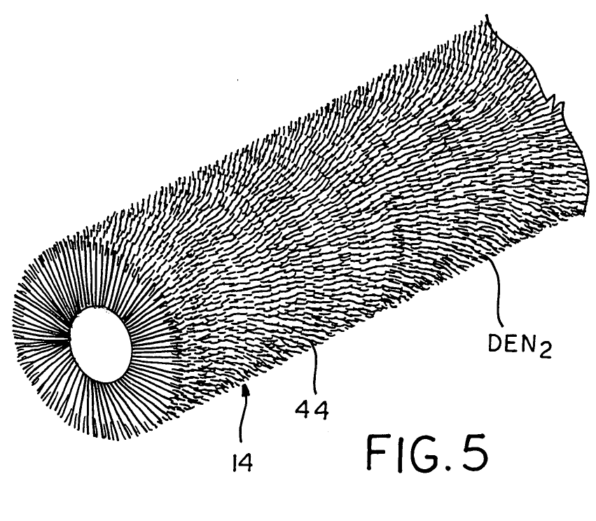

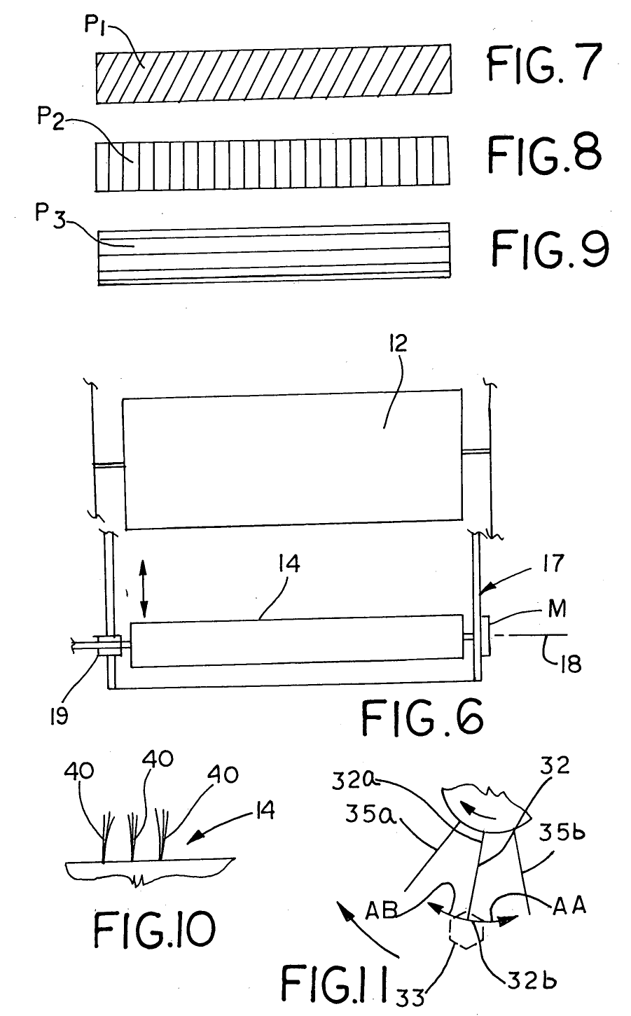

The lower bristle density may be achieved in a number of additional ways. Referring now to FIGS. 7-10, the bristles 32 may be arranged in a spiral or helically flighted pattern P₁ (FIG. 7), a pattern P₂ consisting of a series of rows oriented transversely relative to the axis 18 of the brush 14 (FIG. 8), or a pattern P3 consisting of a series of rows oriented parallel elative to the axis 18 of the brush 14 (FIG. 9). Further, as shown in FIG. 10, the bristles 32 may be grouped in clumps 40. Other suitable arrangements may prove suitable.

Referring now to FIG. 11, one of the bristles 32 is shown, along with a bristle 35a that is disposed in front of the bristle 32 relative to the path A, and a bristle 35b that is disposed behind the bristle 32 relative to the path A. Although only a single bristle 32 is shown, it will be appreciate that, and viewing FIG. 11 in conjunction with FIG. 5, the bristles 32, 35a, and 35b may comprise a clump or group of bristles spaced away from each other. When the brush 14 is rotated, it will be appreciated that the end 32b of the bristle 32 will be delayed in its progress along the path A due to contact with the flicker bar 33, causing the end 32b to deflect along an arc AA relative to where the end 32b would be had no contact been made. Upon ceasing contact with the flicker bar 33, and owing to the relative stiffness of the bristle 32, the end 32b will swing forward along the arc AA, catching up and perhaps passing the position the end 32b would be had no contact been made with the flicker bar 33. Should the end 32b swing forward enough to pass it's initial position, the end 32b will do so along the path of an arc AB. It will be appreciated that at no time does the end 32b actually travel backward along the path A, but instead its normal progress along the path A is delayed due to contact with the flicker bar 33.

When assembled according to the teachings of the disclosed example, the brush 14 may exhibit one or more advantageous characteristics. For example, the Polyester construction absorbs virtually no water or solvent due to the lower absorbency characteristic ABS₂. In some applications this may allow the bristles 32 to remain in their original condition for a longer usage period. Further, the increased stiffness S₂ and lower bristle density D₂ relative to the stiffness and density of the conventional brush 14 act to increase the “flicking” action of the bristles 32 as the bristles 32 pass over the flicker bar 33. Generally speaking, according to the disclosed example the bristles 32 may both snap back more aggressively after passing over the flicker bar 33, and the tips or ends 32b of each bristles 32 may have more room to travel before contacting another bristle such as, for example, the leading bristle 35a or the trailing bristle 35b (FIG. 11). Thus, the brush 14 tends to remain cleaner and, as a result, requires less maintenance, because the brush 14 can more readily dislodge debris and/or moisture.

These density and stiffness characteristics also serve to promote the removal of water from the bristles when the bristles pass over the flicker bar. The brush therefore remains dryer, again resulting in significantly reduced web breaks. These same density and stiffness characteristics further inhibit the build up of debris on the brush 14, as debris is better able to escape from between the bristles because the bristles have more room to deflect and swing as they pass over and then are freed from the flicker bar. Again, this helps to maintain the brush in it's original condition for a longer period of time. Finally, these stiffer bristles provide a more aggressive “bite” and a better cleaning action.

It will be appreciated that the brush 14, except for the above-mentioned properties and characteristics involving bristle material, length, diameter, absorbency and spacing, may be constructed using conventional brush construction techniques. Such techniques are known and typically employed by a number of commercial suppliers generally known in the art. One such supplier is OXY-DRY® GmbH.

Various details and aspects of the various arrangements disclosed may be freely interchanged and/or combined with other details and aspects disclosed herein. No example or embodiment need be considered as mutually exclusive with another example.

The foregoing description is not intended to limit the scope of the invention to the precise form disclosed. It is contemplated that various changes and modifications may be made by those skilled in the art without departing from the spirit and scope of the invention.

What is claimed:

1. A system for cleaning the blanket cylinder of a printing press, the system comprising:
a brush having a plurality of bristles, the brush mounted to an axle and rotatable about a longitudinal axis and arranged to shift from a first position in which the bristles are spaced away from the blanket cylinder to a second position in which the bristles are positioned to contact the blanket cylinder;
the brush operatively coupled to a cam arranged to shift the axle back and forth along the longitudinal axis of the brush;
a flicker bar extending parallel to the brush and positioned to contact at least some of the bristles when the brush is in the second position; and
a conduit arranged for flow communication with a source of cleaning solution, the conduit positioned to direct cleaning fluid toward at least one of the brush and the blanket cylinder.

2. The system of claim 1, wherein the bristles comprise a polyester material having a diameter of twelve thousandths of an inch and an absorbency rate of 0.05 percent.

3. The system of claim 2, wherein an end of each of the bristles travels along a circumferential path at a circumferential speed in response to rotation of the brush about the longitudinal axis, and wherein the bristles are further sized and shaped to have a stiffness sufficient to permit an end of each bristle traveling along the path to be temporarily delayed upon contact with the flicker bar.

4. The system of claim 3, wherein the bristles are further disposed and spaced on the brush according to a bristle density, the bristle density arranged to be sufficiently low to permit the end of each bristle to swing forward along the path immediately after the end of each bristle leaves contact with the flicker bar.

5. The system of claim 4, wherein the bristle density is further arranged such that the end of each bristle swings forward along the path immediately after the end of each bristle leaves contact with the flicker bar without contacting any adjacent bristles.

6. The system of claim 4, wherein each of the bristles is adapted to pick up debris upon contact with the blanket cylinder, and wherein the bristle density and the bristle stiffness are selected to permit the end of each bristle to swing forward along the path after leaving contact with the flicker bar a distance sufficient to dislodge at least a portion of the debris from the bristle.

7. The system of claim 1, the bristles arranged to travel along a path in response to rotation of the brush and comprising a leading bristle and a trailing bristle, the leading bristle disposed in front of the trailing bristle relative to the path, and wherein an end of the trailing bristle swings along an arc upon contact with the flicker bar and upon leaving contact with the flicker bar upon rotation of the brush, the bristles spaced on the brush according to a bristle density, the bristle density chosen such that the end of the trailing bristle swings though the arc without contacting the leading bristle.

8. The system of claim 7, wherein the bristles comprise a polyester material having a diameter of twelve thousandths of an inch and an absorbency rate of 0.05 percent.

9. The system of claim 1, the bristles arranged to travel along a path in response to rotation of the brush and arranged to collect debris upon contact with the blanket cylinder, the bristles comprising a leading bristle and a trailing bristle, the leading bristle disposed in front of the trailing bristle relative to the path, and wherein an end of the trailing bristle swings along an arc upon contact with the flicker bar and upon leaving contact with the flicker bar upon rotation of the brush, the bristles spaced on the brush according to a bristle density, the bristle density chosen such that the end of the trailing bristle swings though the arc a distance sufficient to dislodge the debris without interference with the leading bristle.

10. The system of claim 9, wherein the bristles comprise a polyester material having a diameter of between nine thousandths and sixteen thousandths of an inch, and wherein the material has an absorbency rate of about 0.05 percent.

11. The system of claim 10, wherein the diameter is about nine thousandths of an inch.

12. A blanket wash head for cleaning the blanket cylinder of a printing press, the blanket wash head mounted on a moveable carriage and including an oscillating brush and arranged to supply cleaning solution for cleaning the blanket cylinder, the blanket wash head comprising:
a plurality of bristles arranged on the brush, the bristles arranged to contact the blanket cylinder in response to movement of the carriage toward the blanket cylinder, the bristles sized to contact a flicker bar disposed within the blanket wash head;
the bristles arranged to travel along a path in response to rotation of the brush and arranged to collect debris upon contact with the blanket cylinder, the bristles comprising a leading bristle and a trailing bristle, the leading bristle disposed in front of the trailing bristle relative to the path, and wherein, in response to rotation of the brush, an end of the trailing bristle swings along an arc upon contact with a flicker bar and upon leaving contact with the flicker bar; and
the bristles spaced on the brush according to a bristle density, the bristle density chosen such that the end of the trailing bristle swings though the arc a distance sufficient to dislodge the debris without interference with the leading bristle.

13. The blanket wash head of claim 12, wherein the bristles comprise a polyester material having a diameter of between nine thousandths and sixteen thousandths of an inch, and wherein the material has an absorbency rate of about 0.05 percent.

14. The blanket wash head of claim 13, wherein the diameter is about nine thousandths of an inch.

15. The blanket was head of claim 14, wherein the bristles are arranged in a spiral pattern.

16. The blanket wash head of claim 14, wherein the bristles are arranged in rows.

17. A blanket wash head for cleaning the blanket cylinder of a printing press, the blanket wash head mounted on a moveable carriage and including an oscillating brush and arranged to supply cleaning solution for cleaning the blanket cylinder, the blanket wash head comprising:
a plurality of bristles arranged on the brush, the bristles arranged to contact the blanket cylinder in response to movement of the carriage toward the blanket cylinder;
the bristles sized to contact a flicker bar disposed within the blanket wash head upon rotation of the brush;
the bristles arranged to travel along a path in response to rotation of the brush and arranged to collect debris upon contact with the blanket cylinder;
the bristles further comprising a leading bristle and a trailing bristle, the leading bristle disposed in front of the trailing bristle relative to the path, and wherein, in response to rotation of the brush, an end of the trailing bristle swings along an arc upon contact with a flicker bar and upon leaving contact with the flicker bar; and
the bristles are spaced on the brush according to a bristle density and a bristle stiffness, the bristle density and the bristle stiffness each chosen such that the bristles dislodge debris and moisture carried by the brush upon contact with the flicker bar.

18. The blanket wash head of claim 17, wherein the bristles comprise a polyester material having a diameter of between nine thousandths and sixteen thousandths of an inch, and wherein the material has an absorbency rate of about 0.05 percent.

19. The blanket wash head of claim 18, wherein the diameter is about nine thousandths of an inch.

20. The blanket wash head of claim 18, wherein the bristles are arranged in a spiral pattern.

21. The blanket wash head of claim 18, wherein the bristles are arranged in rows.

22. A rotatable brush for use with a blanket wash head and comprising:
a plurality of bristles;
the bristles having a length sized to contact a flicker bar disposed within the blanket wash head upon rotation of the brush, the bristles arranged to travel along a path in response to rotation of the brush and arranged to collect debris upon contact with the blanket cylinder;
the bristles arranged according to a bristle density, the bristle density being about 50% less than the bristle density of a conventional blanket wash head brush;
the bristles comprising a polyester material having an absorbency of about 0.05 percent; and
the bristles having a diameter relative to a length sufficient to cause an end of each bristle to dislodge debris in response to contact with the flicker bar.

23. The brush of claim 22, wherein the bristles comprise a leading bristle and a trailing bristle, the leading bristle disposed in front of the trailing bristle relative to a rotational path, and wherein, in response to rotation of the brush, an end of the trailing bristle swings along an arc upon contact with the flicker bar and upon leaving contact with the flicker bar, and wherein the bristles density and the bristle stiffness are chosen such that the end of the trailing bristle swings though the arc a distance sufficient to dislodge the debris without interference from the leading bristle.

24. The brush of claim 22, wherein the bristles are arranged in a spiral pattern.

25. The brush of claim 22, wherein the bristles are arranged in rows.

26. The brush of claim 22, wherein the bristles are clumped in groups.

27. The brush of claim 22, wherein the diameter of the bristle relative to the length of a bristle may be expressed as a stiffness ratio, and wherein the diameter and length are sized to give a stiffness ratio of between about 81.7 and about 98.3.
